(19) United States
(12) Patent Application Publication
(10) Pub. No.: US 2017/0197701 A1
(43) Pub. Date: Jul. 13, 2017

(54) COOLING OF AEROSPACE FLIGHT SYSTEMS

(71) Applicant: IOWA STATE UNIVERSITY RESEARCH FOUNDATION, INC., AMES, IA (US)

(72) Inventors: THOMAS P. GIELDA, BELLAIRE, MI (US); PATRICK G. VOGEL, ST. PETERS, MO (US)

(21) Appl. No.: 15/168,812

(22) Filed: May 31, 2016

Related U.S. Application Data
(60) Provisional application No. 62/169,690, filed on Jun. 2, 2015.

(51) Int. Cl. B64C 3/36; B64D 37/34; B64C 1/38; B64D 37/10; B64D 37/30; F02K 7/10; B64C 3/34

(52) U.S. Cl. CPC B64C 3/36; F02K 7/10; B64D 37/34; B64C 3/34; B64D 37/10; B64D 37/30; B64C 1/38

(57) ABSTRACT

The invention relates generally to a novel cooling system and fuel preheating system for use in an advanced, high speed aerospace vehicle. A hydrocarbon fluid, such as fuel is accelerated to supersonic conditions within a cooling channel located proximate a high-temperature flight surface. The hydrocarbon fuel absorbs a heat load as it passes through the cooling channel in the flight control surface prior to the fuel being directed into the aircraft engine.

### CROSS-REFERENCE TO RELATED APPLICATIONS

This application claims priority to U.S. Provisional Patent Application Ser. No. 62/169,690, filed on Jun. 2, 2015.

### STATEMENT REGARDING FEDERALLY SPONSORED RESEARCH OR DEVELOPMENT

Not applicable.

### TECHNICAL FIELD

The invention relates generally to a high efficiency cooling system for aerospace flight systems and flight surfaces such as a high speed vehicle where the surface cooling system also provides fuel pre-heating.

### BACKGROUND OF THE INVENTION

Today's high performance aircraft are extremely complex vehicles, due in part to their significant onboard electrical and computer equipment. This equipment, such as the F-22 and F-35 fighter jets, generate heat that must be dissipated. Due to the heat produced by their advanced avionics systems, these aircraft use a refrigerated fuel to provide sufficient cooling to the onboard electronics.

In addition, other advanced, high performance equipment, such as supersonic or hypersonic aircraft or reusable spacecraft, are subjected to extremely high operating surface temperatures due to the friction they encounter when traveling through the atmosphere at high rates of speed. For example, an advanced aerospace vehicle traveling at Mach 7 at 100,000 feet (approximately 19 miles altitude) may have operating temperatures upwards of 2200 degrees Kelvin (approximately 3500 degrees Fahrenheit) along certain surfaces of the aircraft. Therefore, in order to withstand such temperatures, and associated operating stresses, it is often necessary to fabricate these structures from exotic materials.

Spacecraft, such as the now-retired Space Shuttle operated by the National Aeronautics and Space Administration, used over 24,000 tiles fabricated from silica fibers to protect the orbiter's aluminum skin from temperatures upwards of 2300 degrees Fahrenheit. While this form of thermal insulation provided adequate protection for the orbiter vehicle, this system required uniquely designed and costly insulated ceramic tiles positioned along the exposed surfaces of the orbiter, including the leading edge of the wing and nose areas. As aviation technology continues to advance, it is necessary to provide a more economical and efficient way to cool critical surfaces and components of the aircraft without requiring use of exotic materials.

### SUMMARY

The present invention provides a new and unique system, for cooling flight systems and flight surfaces of aerospace vehicles. The invention can be applied to a variety of flight systems such as electronics, sensors, lasers, RADAR, propulsion components such as inlets, combustors, and nozzles, thereby providing operational benefits. For example, cooling the nozzle regions of an aircraft reduce their thermal signature output, thereby reducing their tendency of being detected.

The invention is also applicable to aircraft surfaces subject to high thermal loading, including the leading edges of wings, tails, flight control surfaces, or the airframe body. The present invention can utilize a variety of fluids for cooling purposes including, but not limited to, hydrocarbons, hydrogen, and hypergolic fuels, or other fluids with applicable vapor pressure.

In an embodiment of the present invention, a system for preheating the fuel of a high speed aircraft is provided. The system comprises a regulator in fluid communication with one or more fuel tanks and a first pump in fluid communication with the regulator. One or more cooling channels are in fluid communication with the first pump where the cooling channels are positioned in close proximity to a surface of the aircraft operating at an elevated temperature. Each of the cooling channels has an inlet end, an opposing outlet end, a throat proximate the inlet end and has an aspect ratio of channel width to channel height, and a channel length extending from between the inlet end and the outlet end where the channel tapers along a half angle formed with respect to a channel axis. A fluid return line connects each of the cooling channels with a fuel injection system of the aircraft engine. Fuel at a first temperature passes through the one or more cooling channels where it is accelerated through the throat to supersonic condition such that it absorbs heat from the surface of the aircraft that is in close proximity to the cooling channel. As a result, the fuel temperature is elevated to a second temperature higher than the first temperature.

In an alternate embodiment of the present invention, a cooling channel adjacent a high temperature surface of an aerospace vehicle is provided. The cooling channel comprises an inlet end, an opposing outlet end thereby establishing a channel length therebetween. The cooling channel has a channel axis, a half angle formed relative to the channel axis, a varying channel height, a channel width, and a throat proximate the inlet end, where the throat has an aspect ratio of channel width to channel height. The inlet end of the channel tapers to the throat and then expands according to the half angle such that a compressible fluid accelerates to a supersonic flow within the cooling channel and provides a medium for absorbing heat from the adjacent high temperature surface of the aerospace vehicle.

In yet another embodiment of the present invention, a method is provided for preheating a fuel for use in an engine of an aerospace vehicle while also cooling a portion of the aerospace vehicle. The fuel-supplied cooling system provided comprises one or more fuel storage tanks containing a hydrocarbon-based fuel, a low pressure pump in fluid communication with the one or more fuel storage tanks for raising the fuel to a first pressure. A plurality of cooling channels is provided adjacent to a surface of the aerospace vehicle, where the plurality of cooling channels receives fuel from the low pressure pump. A high pressure pump is in fluid communication with the plurality of cooling channels and receives fuel being discharged from the plurality of cooling channels and raises the fuel to a second pressure higher than the first pressure from the first pump. The method includes the steps of directing the fuel through the low pressure pump to raise the fuel pressure to a first pressure, directing the fuel through the plurality of cooling channels, where the fuel is accelerated to a supersonic flow, and directing the fuel through the high pressure pump where its pressure is raised to a second pressure before being directed to an engine. As a result of this process, fuel stored onboard the aircraft is used for cooling critical aircraft surfaces, resulting in the fuel absorbing heat from these surfaces and increasing in temperature such that the fuel is preheated prior to combustion in the engine.

Other advantages, features and characteristics of the present invention, as well as the methods of operation and the functions of the related elements of the structure and the combination of parts will become more apparent upon consideration of the following detailed description and appended claims with reference to the accompanying drawings, all of which form a part of this specification.

### BRIEF DESCRIPTION OF THE SEVERAL VIEWS OF THE DRAWINGS

The present invention is described in detail below with reference to the attached drawing figures, wherein:

FIG. 1 is a perspective view of an aerospace vehicle of the prior art.

FIG. 2 is a perspective view of an aerospace vehicle in accordance with an embodiment of the present invention.

FIG. 3 is an elevation view of an aerospace vehicle depicting an embodiment of the present invention.

FIG. 4 is an elevation view of an aerospace vehicle depicting an alternate elevation view of an embodiment of the present invention.

FIG. 5 is a detailed elevation view of a portion of the aerospace vehicle depicted in FIG. 4.

FIG. 6 is a perspective view of a control surface of an aerospace vehicle having a cooling channel in accordance with an embodiment of the present invention.

FIG. 7 is an alternate perspective view of the control surface of FIG. 6 in accordance with an embodiment of the present invention.

FIG. 8 is a cross section view of a cooling channel in accordance with an embodiment of the present invention.

FIG. 9 is a perspective view of a portion of a cooling channel in accordance with an embodiment of the present invention.

FIG. 10 is a perspective view of an inlet portion of a cooling channel in accordance with an embodiment of the present invention.

FIG. 11 is a perspective view of a portion of a surface of an aerospace vehicle having multiple cooling channels.

### DETAILED DESCRIPTION

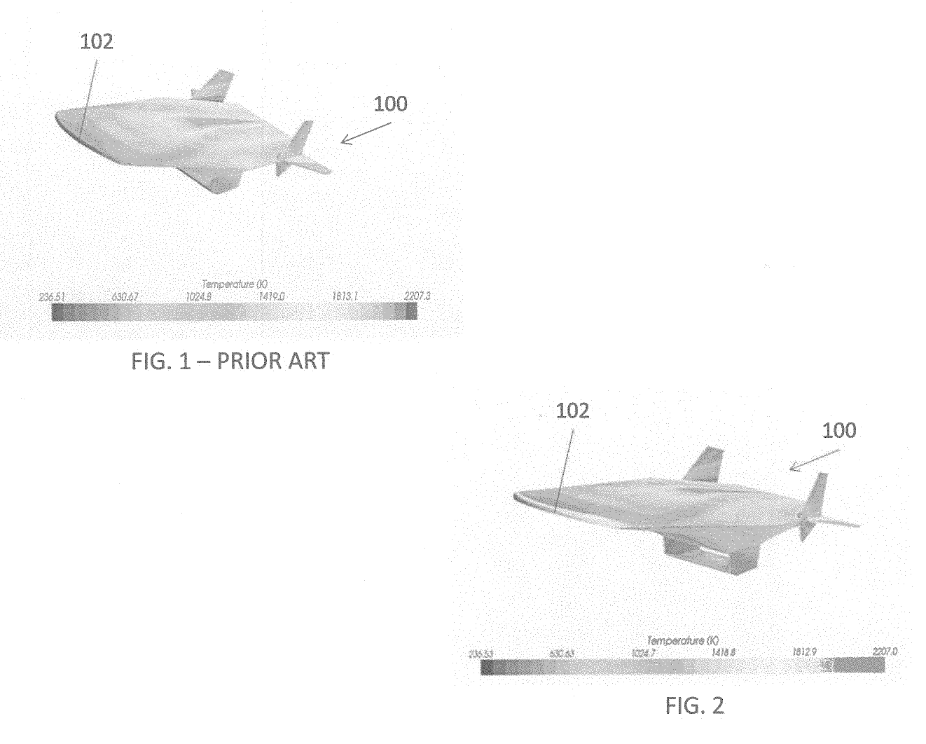

The present invention provides systems and methods for improving the cooling of an advanced aerospace vehicle that operates at high speeds and with high surface temperatures. Aspects of the present invention are depicted with respect to FIGS. 1-11.

Referring initially to FIG. 1, an aerospace vehicle 100, in accordance with the prior art, is depicted in perspective view. The vehicle 100 represents a class of high speed aircraft operating at high altitudes and subject to high temperatures due to the friction of air passing over the various surfaces of the vehicle. These high aerodynamic heating rates typically occur on critical flight surfaces such as the nose, wing leading edge, leading edges of the tail or elevator, and proximate engine inlets and nozzles. Representative aerospace vehicles include, but are not limited to, hypersonic aircraft. For the vehicle 100 depicted in FIG. 1, traveling at an altitude of 100,000 feet (approximately 19 miles) and a speed of Mach 7, the peak temperatures on the vehicle 100 are found at the nose region 102 where the temperature exceeds 2200 degrees Kelvin (over 3500 degrees Fahrenheit).

Turning to FIG. 2, the same aerospace vehicle 100 operating at the same altitude and speed as that of FIG. 1 is depicted. However, the vehicle 100 is operating at these conditions while utilizing a cooling system in accordance with an embodiment of the present invention, as discussed below. As a result of operating the onboard cooling system with active cooling directed to the high temperature surfaces, the maximum temperature in the nose 102 of the vehicle 100 drops significantly, to approximately 1800-2000 Kelvin.

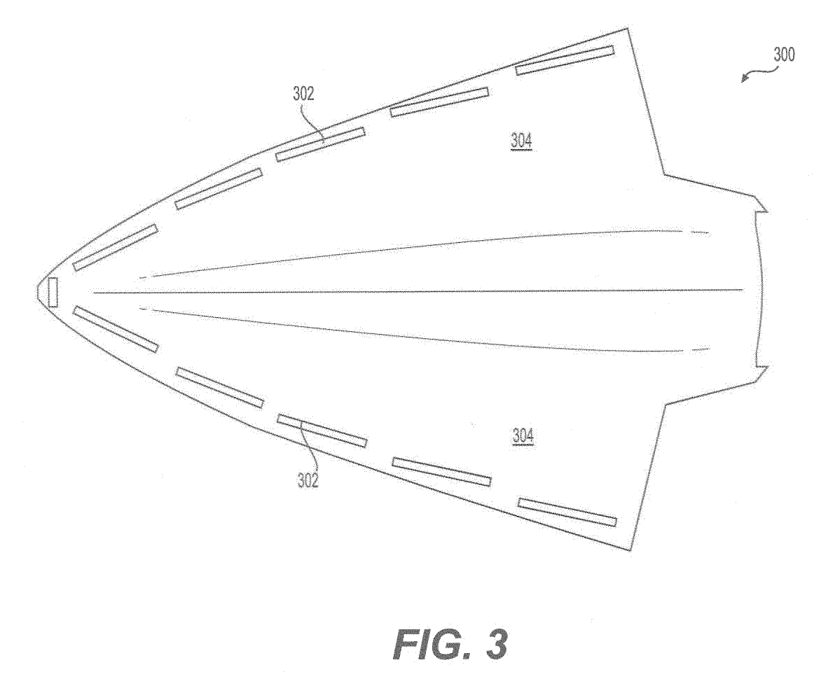

Referring to FIGS. 3-11, more specific details of the present invention are shown. Embodiments of the present invention are configured to be installed in critical flight surfaces of an aerospace vehicle, such as leading edges of the wings, tail, aircraft nose and control surfaces. An aerospace vehicle 300 is depicted in FIG. 3 and includes a series of cooling channels 302 adjacent the leading edge of the wing 304 of the vehicle 300. A plurality of cooling channels 302 is necessary in order to provide adequate cooling to a larger surface area, such as a wing leading edge. A representative plurality of cooling channels 302 is shown in FIG. 3. The depictions in FIGS. 3-5 are meant to be merely representative of an embodiment of the present invention, as the exact size and location will vary depending on the vehicle geometry and expected flight conditions and operating temperatures. Factors such as vehicle length, maximum expected flight Mach number, material composition of the surfaces to be cooled, and the amount of heat to be removed are some of the factors considered when determining the cooling channel size and location in the vehicle 300.

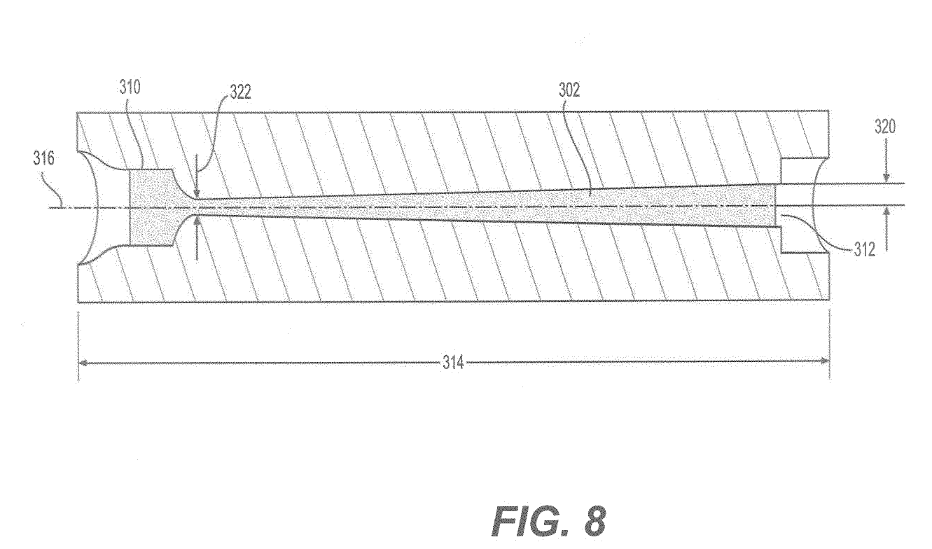

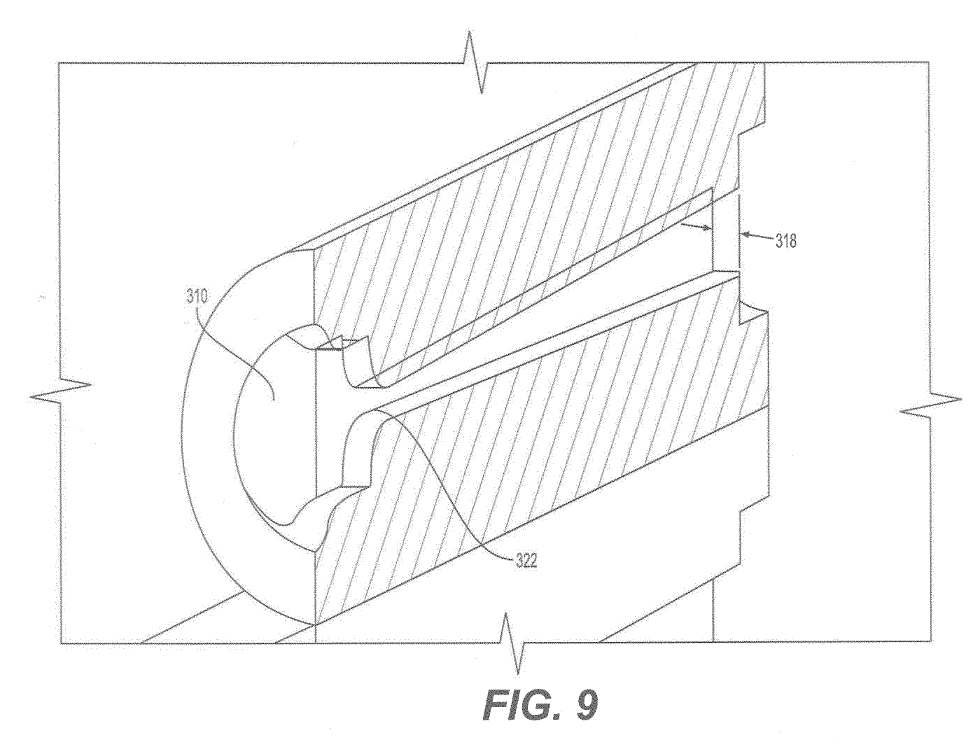

Further details of the cooling channel 302 are shown in FIGS. 8-10. In an embodiment of the present invention, the cooling channel 302 comprises an inlet end 310 and an opposing outlet end 312, thereby establishing a channel length 314 therebetween where the channel 302 extends along a channel axis 316. The cooling channel 302 also has a channel height that varies along the channel length 314, as can be seen from FIGS. 8 and 9, and a channel width 318, which is measured as extending into the sectional views shown in FIG. 9. The channel height is measured using a half angle 320, which is the angle measurement from the channel axis 316 to the upper or lower surface of the cooling channel 302. While the half angle 320 can vary depending on the cooling channel geometry, acceptable half angles for an embodiment of the present invention are approximately 0.5-3 degrees and more preferably, 1-2.5 degrees.

The half angle 320 can vary depending on the cooling fluids passing through the cooling channel 302, as a variety of cooling fluids can be used. The optimum half angle is a function of the difference in density of the cooling fluids. In general, the fluid with the higher density ratio will be able to operate at higher half angles, as the higher half angle allows the area of the cooling channel to increase faster, thus providing space for the vapor to flow in the channel 302. The half angle for hydrocarbon-based systems is slightly smaller than for water-based systems. However, as one skilled in the art will understand, the enthalpy of the system, or the energy required to transform the fluid from liquid to vapor, must also be considered. For example, it takes approximately twenty times more energy to change water from liquid to vapor than it does for a hydrocarbon fuel. For example the enthalpy transformation of JP8 fuel is approximately 333 kj/kg whereas the enthalpy transformation for water is approximately 2.4 Mj/kg. Thus, water could be a good source for cooling. However, water typically does not have any other use on the high-speed advanced performance aircraft discussed above. Further, as one skilled in the art understands, carrying extra weight onboard an aircraft, such as in the form of water, creates performance drawbacks for the aerospace vehicle. Engine efficiency is reduced due to the additional lift required to compensate for the extra weight. Furthermore, carrying water exclusively for cooling also requires a way to consume the now-heated water or a system must be provided to cool the water for re-use, thus adding additional weight to the aircraft.

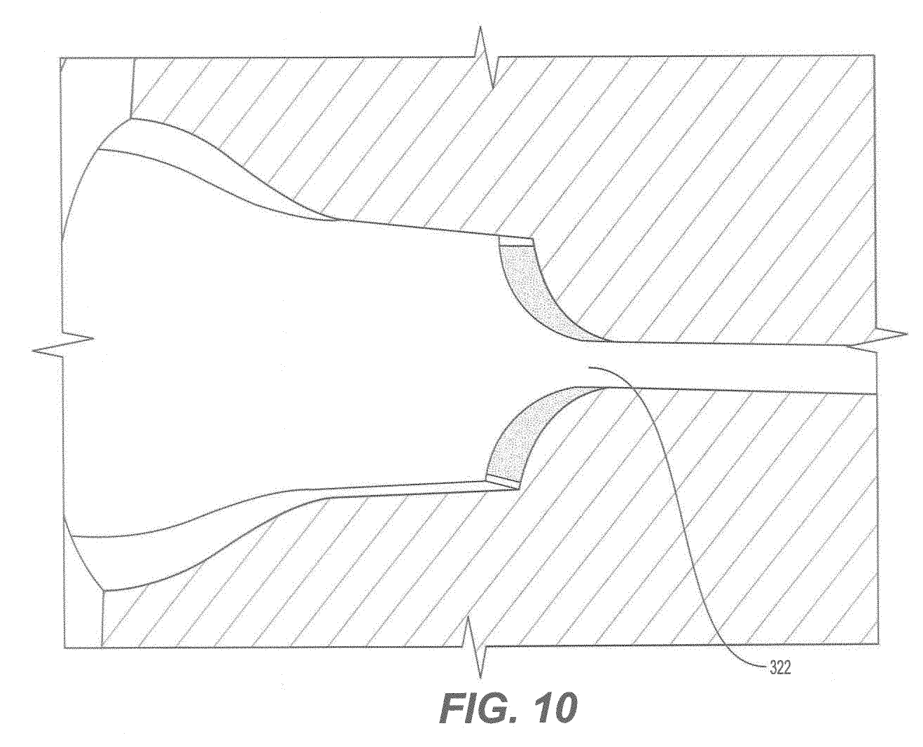

Referring to FIGS. 8-10, the cooling channel 302 also includes a throat 322 proximate the inlet end 310, where the throat 322 has an aspect ratio defined as channel width to channel height. For the embodiments of the present invention discussed herein, acceptable aspect ratios for the throat 322 can range from approximately 1 to 5. As shown more clearly in FIGS. 9 and 10, the cooling channel 302 tapers from the inlet end 310 to the throat 322, the minimum area in the cooling channel 302, before expanding according to the half angle 320 along the channel length 314.

As with other features of the cooling channel 302, the length 314 will also vary depending on a variety of factors such as its application in the vehicle, operating temperature of the adjacent aircraft surface, and type of cooling fluid passing through the channel, to name a few. The length 314 is typically characterized in terms of the height of the channel. Typically, the cooling channels 302 will range in length approximately 150-250 times the channel height. Thus, if the channel has a height of one millimeter, the cooling channel length 314 would extend approximately 150-250 millimeters.

Due to the geometry of the cooling channel 302, the fluid passing from the inlet end 310 and through the reduced area at the throat 322 is accelerated to a supersonic flow. In the embodiment of the present invention depicted in FIGS. 9-11, the shape of the inlet contracts according to a golden section or golden ratio to the throat 322. The golden section, while being a well understood geometrical configuration, is used as a pattern for contracton in the present invention as a result of observations by the inventors and through detailed laboratory experimentation. Accordingly, in one embodiment of the present invention, the inlet end 310 of the channel 302 is to be at least five times larger than the height of throat 322.

As discussed above, water would form an acceptable fluid for cooling, but has distinct drawbacks. Instead of water, another compressible fluid that can be used is a hydrocarbon fluid, such as the fuel that is used in the combustion process by the aircraft engine, such as JP8. The fuel being used as a coolant has an initial temperature in the range of 40-120 degrees Fahrenheit when in the storage tanks, and preferably towards the lower end of this range in order to maximize the possible thermal sinks. As a result of the fuel being accelerated to a supersonic flow and passing through the cooling channel 302, the fuel absorbs heat from the flight surfaces adjacent the cooling channel 302. More specifically, the fuel, which is raised in pressure, passes through the convergent-divergent nozzle formed via the inlet and throat of the cooling channel 302. As the fluid accelerates towards the throat of cooling channel 302, the pressure of the fluid decreases. As the pressure drops, the static pressure of the fluid will be lower than the vapor pressure of the fluid. At this point, the fluid will begin to cavitate, or change phase from liquid to vapor. The cavitation will start at nucleation sites on the walls of the channel 302 just downstream from the throat 322. As the fluid begins to cavitate, bubbles of fuel vapor are created. The dispersed fuel vapor bubble/liquid mixture has a sound propagation spped that is significantly lower than the speed of sound in pure liquid or pure vapor. When the fluid/vapor mixture is in this stage, it has flow properties similar to supersonic flow in a nozzle. As the speed of the flow exceeds the local speed of sound, the flow now behaves like a supersonic nozzle. As the fluid rapidly accelerates, it continues to drop in pressure and as the fluid passes below the saturation line, a cold sink is generated. This cold sink will then absorb the heat from the high temperature aircraft surfaces adjacent the cooling channels 302. As the fluid picks up this heat, as well as due to frictional losses, the fluid will then shock back to a subsonic condition. Through the process outlined above, the hydrocarbon fluid, or jet fuel, absorbs heat sufficient to raise the fuel temperature to approximately 200 degrees Fahrenheit. This raised temperature is well below the fuel coking temperature or auto-ignition levels.

For the embodiment depicted and discussed herein, no insulation is provided around the cooling channel 302. This configuration ensures that the cooling fluid (fuel) is sufficiently exposed to the heat source to absorb heat from the flight surfaces of the vehicle. However, care must also be exercised to ensure that the temperature increase of the hydrocarbon cooling fluid does not increase, to the point of auto-ignition. Thus, it is possible in alternate embodiments of the present invention that a form of insulation could be applied between the flight surface and the cooling channel 302.

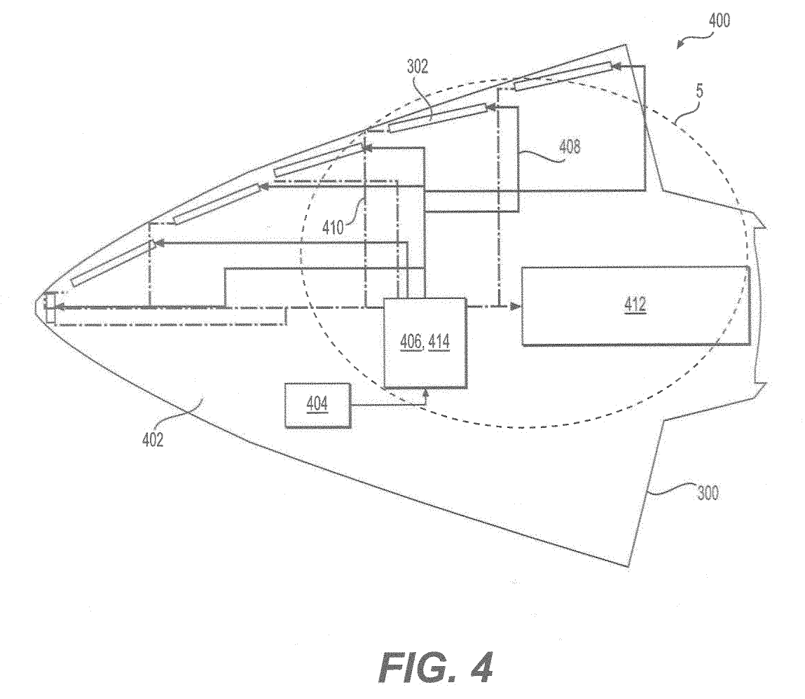

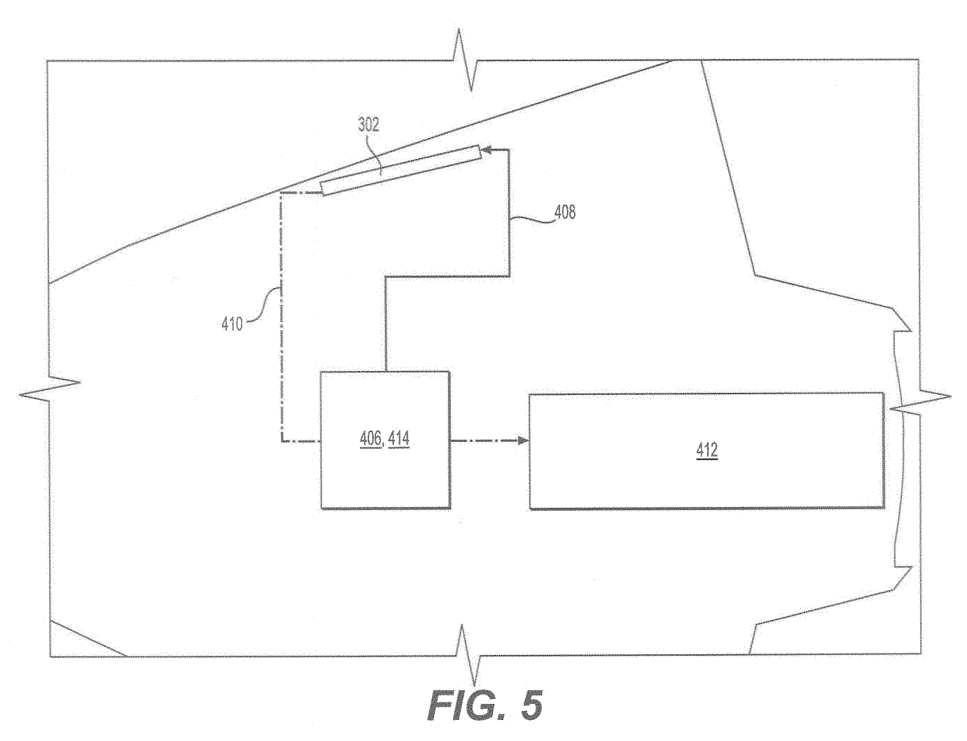

The present invention also provides a system and method for preheating the fuel used as cooling fluid. Referring back to FIGS. 4 and 5, an aerospace vehicle 300 utilizing the present invention is again depicted, where cooling channels 302 are shown in close proximity to a surface of the aircraft. In FIG. 4, only a few representative cooling channels 302 are shown for clarity purposes.

A fuel preheating system 400 for a high speed aircraft, such as an aerospace vehicle is provided utilizing one or more cooling channels 302, as discussed above, where the cooling channels 302 are positioned in close proximity to a surface of the aircraft 300 that is subjected to high temperatures. The cooling channel 302 comprises an inlet end 310 and an opposing outlet end 312, thereby establishing a channel length 314 therebetween where the channel 302 extends along a channel axis 316. The cooling channel 302 also has a channel height that varies along the channel length 314 according to the half angle 320 formed with respect to the channel axis 316, as can be seen from FIGS. 8-10. The cooling channel 302 also has a channel width 318, which is measured as extending into the sectional views shown in FIGS. 9 and 10. The cooling channel 302 also comprises a throat 322 proximate the inlet end 310 and having an aspect ratio of channel width to channel height.

Referring back to FIGS. 4 and 5, the fuel preheating system 400 comprises one or more fuel tanks 402 from which fuel at a first temperature is withdrawn through a regulator 404, where the regulator 404 controls the fuel flow rate from the one or more fuel tanks 402. The size and location of the one or more fuel tanks 402 can vary depending on the aircraft configuration. For example, as one skilled in the art will understand, for advanced hypersonic aircraft, fuel may be stored in the aircraft body itself instead of external fuel tanks. Fuel is then directed through a first pump 406 where its pressure is raised to a first pressure (approximately 2 bar) and then directed to the one or more cooling channels 302 through a cooling fluid supply line 408. This is more clearly shown in FIG. 5, which depicts a single cooling channel arrangement. Power for the first pump 406 is provided by the aircraft auxiliary power unit (not shown).

The fuel from the fuel tank 402 passes through the cooling channel 302 where it is accelerated to a supersonic flow, as described above. Through this process, the fuel temperature increases to approximately 200 degrees Fahrenheit by absorbing heat from the surrounding flight surfaces. After exiting the one or more cooling channels 302, the fuel, now at a second temperature higher than the first temperature, is directed through a cooling fluid return line 410. The return line(s) 410 connect each of the one or more cooling channels 302 with a fuel injection system (not pictured) of an aircraft engine 412. Depending on the pressure loss associated with the preheating system, the fuel being returned from the one or more cooling channels 302 may need to be increased in pressure by a second pump 414 prior to being injected into the engine. The second pump 414 raises the fuel pressure to a higher pressure than that of the first pump 406. The second pump 414, or high pressure pump, elevates the fuel pressure to approximately 1000 psi. One such acceptable pump is an Eaton gear pump used on jet engines. The fuel is then directed to the engine 412 for use in the combustion process. Raising the fuel temperature via the fuel preheating system 400 provides both the benefit of cooling the critical aircraft surfaces but also raising the fuel temperature to the desired combustor inlet conditions to provide improved combustion efficiency without the need of a separate fuel heater to be carried onboard the aircraft.

The flow rate through the fuel preheating system 400 will vary based on a variety of factors including aircraft size, quantity of critical surfaces to be cooled, and performance requirements of the engine. For example, for an embodiment of the present invention, such as an aerospace vehicle similar to that depicted in FIGS. 1 and 2, having a vehicle length of 11 meters and traveling at Mach 5.5, the propulsion system requires a fuel flow rate of approximately 1.2 kg/sec. This is based on the performance of a ramjet engine. Such a vehicle operating at these conditions would have surface temperatures of approximately 1675 deg. Kelvin (1400 deg. Celsius) along critical surfaces such as the wing leading edge. The same vehicle would require approximately 1.0 kg/sec of fuel to be used as cooling fluid through the cooling channels. Utilizing this flow rate through the cooling channels described above results in surface temperatures being lowered to approximately 875 deg. Kelvin (600 deg. Celsius). Thus, all fuel passing through the cooling channels cools the critical flight surface, is preheated for combustion, and is then utilized in the combustion process of the propulsion system. The present invention consumes all fuel that undergoes the preheating process in the subsequent step of combustion thus eliminating the need to cool the fuel, use refrigerated fuel, or recirculate the fuel to the storage tanks.

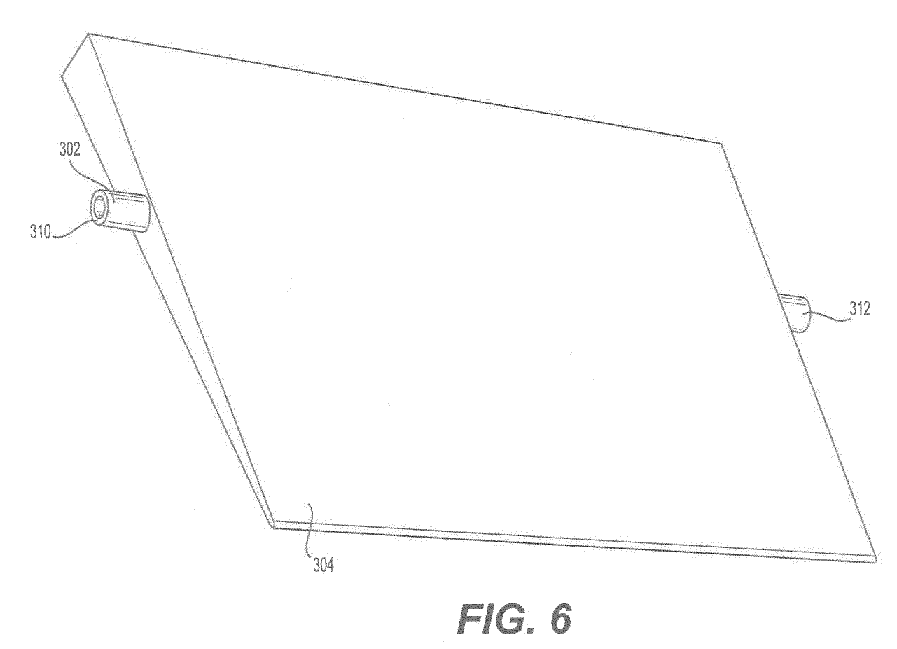

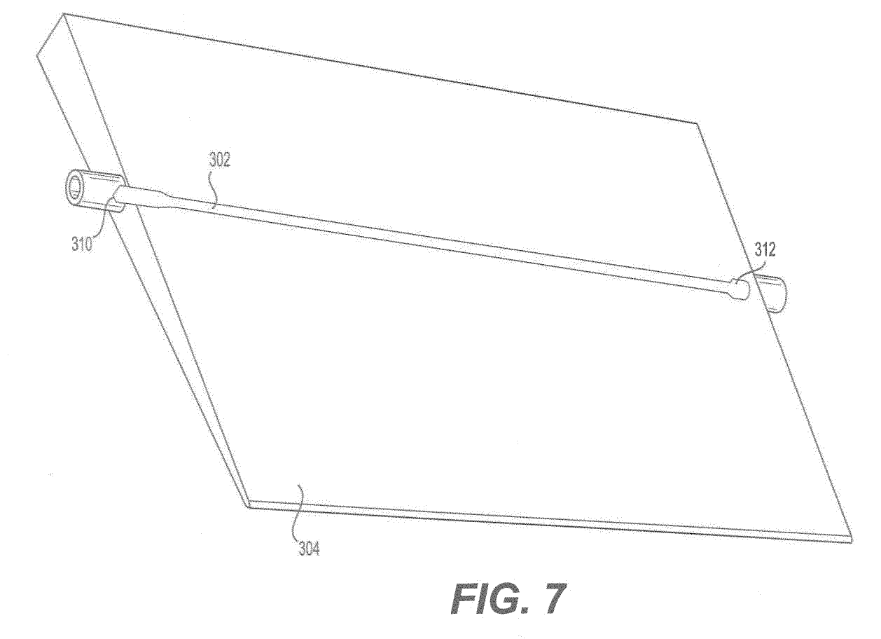

Referring now to FIGS. 6 and 7, a way of integrating a cooling channel in a flight control surface, such as a wing leading edge, is depicted. The cooling channel 302 is positioned as close to the leading edge of the wing 304 as possible, given the structural limitations of the wing. It is also desirable to utilize a traditional quick connect/disconnect type structure between the inlet of the cooling channel 310 and the supply of the cooling fluid. This will allow for ease of repair and replacement of the wing components as may be required.

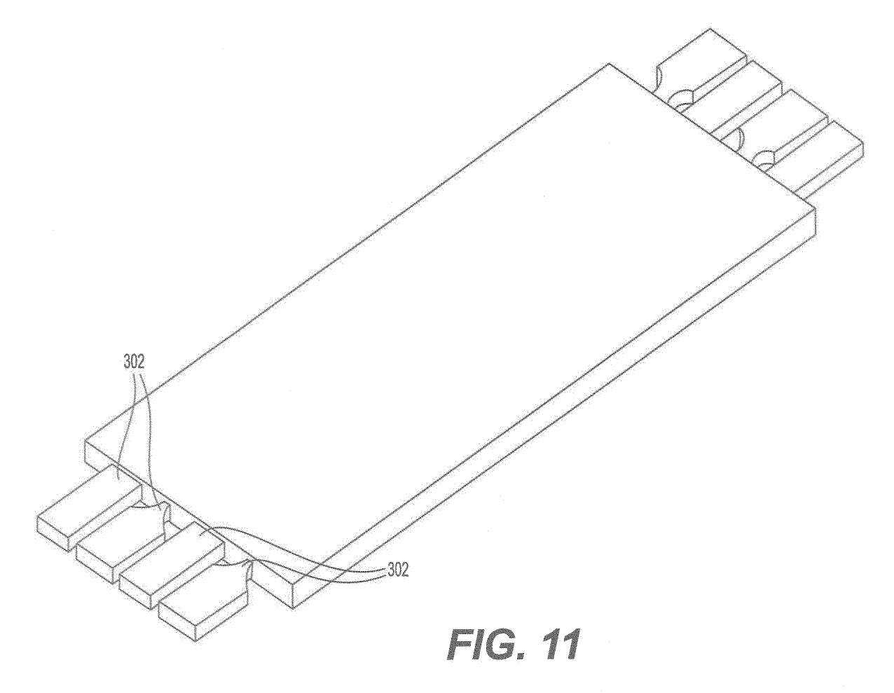

As discussed earlier, the exact quantity and position of the cooling channels will vary and be based on a number of conditions associated with the aerospace vehicle. For example, fewer cooling channels will be required for surface materials constructed from high temperature resistant materials or where operating temperatures are lower, while more cooling channels will be required for surfaces fabricated from a lower temperature material or operating at a higher temperature. Depending on the flight surface to be cooled and the required channel geometry, a variety of manufacturing techniques can be utilized to form the cooling channels. One such technique is known as additive manufacturing, where the aircraft surface and cooling channel can be built in an additive manner by adding layers of material in the shape of the cooling channel profile to form the desired geometry. Furthermore, where additional cooling is required, the flight control surface may include multiple cooling channels, as depicted in FIG. 11, where the channels are oriented adjacent to each other.

While the invention has been described with respect to what is presently understood as an embodiment of the invention, the applicant understands that the use of the present invention may extend to other related aerospace components and activities. For example, the cooling configuration discussed herein may be applied to cool other high temperature components such as first stage turbine blades and the outer surface of combustion liners.

Although a preferred embodiment of this invention has been disclosed, a worker of ordinary skill in this art would recognize that certain modifications would come within the scope of this invention. For that reason, the following claims should be studied to determine the true scope and content of this invention. Since many possible embodiments may be made of the invention without departing from the scope thereof, it is to be understood that all matter herein set forth or shown in the accompanying drawings is to be interpreted as illustrative and not in a limiting sense.

From the foregoing, it will be seen that this invention is one well adapted to attain all the ends and objects hereinabove set forth together with other advantages which are obvious and which are inherent to the structure.

It will be understood that certain features and subcombinations are of utility and may be employed without reference to other features and subcombinations. This is contemplated by and is within the scope of the claims.

What we claim is:

1. A fuel preheating system for a high speed aircraft, the system comprising:
one or more fuel tanks;
a regulator in fluid communication with the fuel tank;
a first pump in fluid communication with the regulator;
one or more cooling channels in fluid communication with the first pump, each of the cooling channels positioned in close proximity to a surface of the aircraft operating at an elevated temperature and each of the cooling channels having:
an inlet end;
an opposing outlet end;
a throat proximate the inlet end having an aspect ratio of channel width to channel height; and,
a channel length extending between the inlet end and outlet end, the channel tapered and having a half angle formed with respect to a channel axis; and,
a fluid return line connecting each of the cooling channels with a fuel injection system of an aircraft engine;
wherein fuel in the one or more fuel tanks has a first temperature and fuel in the fluid return line has a second temperature higher than the first temperature.

2. The system of claim 1, wherein the fuel in the fuel tank has a first temperature of approximately 40-120 deg. Fahrenheit.

3. The system of claim 1, wherein the fuel in the fluid return line has a second temperature of approximately 200 deg. Fahrenheit.

4. The system of claim 1 further comprising a second pump for raising pressure of the fuel to a pressure sufficient for injection into the aircraft engine and higher than the first pump.

5. The system of claim 1, wherein the first pump provides fuel to the plurality of cooling channels at a pressure of approximately 2 bar.

6. The system of claim 1, wherein the aspect ratio of the throat is approximately 1 to 5.

7. The system of claim 6, wherein the half angle of the channel is approximately 0.5-3 degrees.

8. The system of claim 1, wherein the one or more cooling channels are located in one or more high temperature aircraft surfaces comprising an aircraft wing, control surface of a wing, tail, or nose region.

9. The system of claim 1, wherein all of the fuel that is directed through the one or more cooling channels is then injected into the aircraft engine for combustion.

10. A cooling channel adjacent a surface of an aerospace vehicle, the surface operating at a high temperature, the cooling channel comprising:
an inlet end and an opposing outlet end, thereby establishing a channel length therebetween and having a channel axis;
a varying channel height;
a channel width;
a throat proximate the inlet end, the throat having an aspect ratio of a channel width to the channel height;
the channel having a half angle formed along the channel axis;
wherein the inlet end tapers to the throat and the cooling channel expands according to the half angle along the channel length, such that a compressible fluid passing through the inlet is accelerated to form a supersonic flow thereby increasing the heat transfer from the surface and to the compressible fluid.

11. The cooling channel of claim 10, wherein the compressible fluid passing through the channel is a liquid hydrocarbon.

12. The cooling channel of claim 11, wherein the liquid hydrocarbon is supplied to the inlet end from a fuel tank and exits the outlet end and is directed to an engine of the aerospace vehicle.

13. The cooling channel of claim 12, wherein the half angle is approximately 1-2.5 degrees.

14. The cooling channel of claim 13, wherein the channel length is approximately 150-250 times the channel height.

15. The cooling channel of claim 9, wherein the surface of the aerospace vehicle is a leading edge of a wing.

16. A method of preheating a fuel for use in an engine of an aerospace vehicle while cooling a portion of the aerospace vehicle, the method comprising:
providing a fuel-supplied surface cooling system comprising:
one or more fuel storage tanks containing a hydrocarbon-based fuel having a fuel pressure;
a low pressure pump in fluid communication with the one or more fuel storage tanks for drawing the fuel from the one or more storage tanks and raising its pressure to a first pressure;
a plurality of cooling channels positioned adjacent to a surface of the aerospace vehicle, the plurality of cooling channels in fluid communication with the fuel from the low pressure pump;
a high pressure pump in fluid communication with the plurality of cooling channels for receiving the fuel from the plurality of cooling channels and raising fuel pressure prior to injection into an engine of the aerospace vehicle, the high pressure pump raising the fuel to as second pressure, the second pressure higher than the first pressure;
directing the fuel through the low pressure pump to raise the fuel pressure to a first pressure;
directing the fuel through the plurality of cooling channels, where the fuel is accelerated to create a supersonic flow;
directing the fuel through the high pressure pump where the fuel pressure is increased to a second pressure in accordance with predetermined engine requirements; and,
directing the fuel into the engine.

17. The method of claim 16, wherein the plurality of cooling channels each comprise an inlet end and an opposing outlet end, thereby establishing a channel length therebetween and extending along a channel axis, a varying channel height, a channel width, a throat proximate the inlet end, the throat having an aspect ratio of a channel width to the channel height, a half angle formed along the channel axis, wherein the inlet end tapers to the throat, such that a compressible fluid passing through the inlet is accelerated to form a supersonic flow thereby increasing the heat transfer from the surface and to the compressible fluid.

18. The method of claim 17, wherein the fuel exiting the plurality of cooling channels is at a higher temperature than the fuel entering the plurality of cooling channels.

19. The method of claim 18, wherein the fuel entering the plurality of cooling channels ranges between 40 degrees Fahrenheit and 120 degrees Fahrenheit and the fuel exiting the plurality of cooling channels is approximately 200 degrees Fahrenheit.

20. The method of claim 17, wherein the channel length is approximately 150-250 times the channel height.
